(19) United States
(12) Patent Application Publication
(10) Pub. No.: US 2025/0384074 A1
(43) Pub. Date: Dec. 18, 2025

(54) LARGE LANGUAGE MODEL SECURITY SUMMARIZATION

(71) Applicant: Andromeda Security, Los Altos, CA (US)

(72) Inventors: Gaurav Rastogi, San Francisco, CA (US); Kevin Alejandro Roundy, El Segundo, CA (US); Lavanya Sita Tekumalla, Bengaluru (IN); Kamalakannan Congevaram Muralidharan, Milpitas, CA (US)

(21) Appl. No.: 19/236,821

(22) Filed: Jun. 12, 2025

Related U.S. Application Data
(60) Provisional application No. 63/659,761, filed on Jun. 13, 2024.

(51) Int. Cl. G06F 16/34; H04L 9/40

(52) U.S. Cl. CPC G06F 16/345; H04L 63/0263; H04L 63/0272

(57) ABSTRACT

Cloud log data and contextual information is received. Knowledge is harvested from the cloud log data and the contextual information. The knowledge that is harvested is condensed by extracting security critical information from the knowledge. A human readable summary is generated by summarizing the condensed knowledge.

### CROSS REFERENCE TO OTHER APPLICATIONS

This application claims priority to U.S. Provisional Patent Application No. 63/659,761 entitled LLM SECURITY SUMMARIZATION filed Jun. 13, 2024 which is incorporated herein by reference for all purposes.

### BACKGROUND OF THE INVENTION

Cloud system administrators often have access to vast amounts of user activity data from various sources, including cloud provider logs (e.g., AWS™ CloudTrail”), Okta™ logs, and identity, resource and permission details from AWS™. The volume and fragmentation of this cloud system data can be overwhelming, making it difficult to extract meaningful insights. Nonetheless, cloud system administrators continue to seek to patterns into user behaviors to enhance security.

### BRIEF DESCRIPTION OF THE DRAWINGS

Various embodiments of the invention are disclosed in the following detailed description and the accompanying drawings.

FIG. 1 is a block diagram of a system for producing human readable summaries of cloud data in accordance with some embodiments.

FIG. 2A is a block diagram of a statistical and ML model module in accordance with some embodiments.

FIG. 2B is a block diagram of a system for summarizing a chunks of information in accordance with some embodiments.

FIG. 3 is a flow diagram of a process for generating a human readable summary of cloud data in accordance with some embodiments.

FIG. 4 is a flow diagram of a process for harvesting knowledge from cloud data in accordance with some embodiments.

FIG. 5 is a flow diagram of a process for condensing knowledge of cloud data in accordance with some embodiments.

FIG. 6 is a flow diagram of a process for summarizing condensed knowledge in accordance with some embodiments.

FIG. 7 is a flow diagram of a process for training a summarization model in accordance with some embodiments.

FIG. 8 is a flow diagram of a process for training a summarization model using feedback in accordance with some embodiments.

FIG. 9 is a flow diagram for generating an augmented dataset in accordance with some embodiments.

FIGS. 10A-10B depicts an example of a condenser input in accordance with some embodiments.

FIG. 11 depicts an example of a condenser output in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Enterprises (e.g., companies, governments, organizations, etc.) employ cloud systems to provide services, hosts networks, store data, etc. These cloud systems process a large volume of activity from many users, including actions and/or requests. Cloud systems are susceptible to malicious activity by actors, such as compromised users, hackers, or individuals who have gained access through phishing. These activities generate extensive cloud log data for the many activities associated with the plurality of users which engage with the cloud system. To detect and prevent malicious behavior, cloud system administrators must analyze this vast amount of cloud data. Summarizing the log data into a human-readable format is often used for identifying suspicious patterns.

However, extracting useful information from the vast cloud log data is challenging. Cloud logs are often very verbose, include a large amount of irrelevant data, and may lack critical contextual information. Existing approaches to summarize such cloud log data often fail to generate summaries that are sufficiently meaningful for use in security or operational contexts.

One approach to extract meaningful insights from large volumes of cloud log data is to process the data using a machine learning (ML) application, such as a general-purpose Large Language Model (LLM). For example, the cloud log data may be provided to the LLM together with a prompt that includes instructions to identify potential malicious activity. The output generated by the LLM can be analyzed by humans, such as cloud information security officers (CISOs), who may use this information to detect and prevent cloud-based vulnerabilities.

However, general-purpose LLMs (e.g., ChatGPT™, ClaudeAI™, Google Gemini™, . . . , etc.) frequently fail to extract meaningful insights from cloud log data. This failure may be attributed to multiple factors. A primary limitation is that these general-purpose LLMs are not specifically trained on cloud log data. As a result, these models often engage in superficial pattern recognition, producing responses that are grammatically coherent, but lacks any substance.

Accordingly, the use of general-purpose LLMs for summarizing cloud log data presents several disadvantages. These include the inability to effectively distinguish between relevant and irrelevant information from a security-audit perspective. Further, malicious activities are often interleaved with and hidden in benign workflows, making their detection even more difficult for general-purpose LLMs. Lastly, such models may inadvertently omit critical events recorded in the cloud log data, resulting in incomplete or misleading summaries. Information that is relevant from a security-audit perspective includes these critical events.

The systems and methods disclosed herein enable the efficient generation of human readable summaries from large volumes of cloud log data and associated contextual information. These human readable summaries can be used for efficient detection/prevention of security vulnerabilities. Cloud log data and contextual information are received. Knowledge from cloud log data and contextual information is harvested. The knowledge is condensed by extracting security critical information from the knowledge. A human readable summary is generated by summarizing the condensed knowledge, providing actionable insights in an accessible format.

The systems and methods disclosed herein improve upon existing solutions by using an agent-based approach to analyze the and pre-process the cloud log data before the cloud log data is provided to a general-purpose LLM. Preprocessing the data may include using one or more ML models for task-specific analysis, condensing the data to extract critical information, and/or using LLMs in a particular manner (e.g., using Retrieval Augmented Generation (RAG), fine-tuning, using specific training data, etc.). The systems and methods disclosed herein can analyze contextual data with the cloud log data to generate more accurate and actionable security insights, for example, by prioritizing the analysis of higher-risk actions. Furthermore, the systems and methods disclosed herein can be used to extract cloud workflows including interleaved workflows that may obscure malicious behavior. The generation of a human readable summary allows a cloud administrator to efficiently review large volumes of cloud log data. The summarization process is designed to preserve critical events, thereby reducing the likelihood of omitting security-relevant information from the summary.

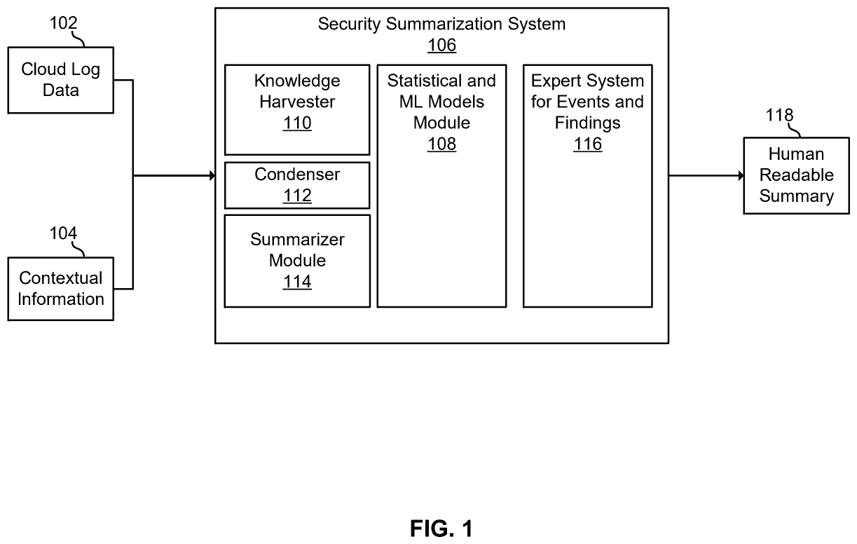

FIG. 1 is a block diagram of a system for producing human readable summaries of cloud data in accordance with some embodiments. In the example shown, system 100 includes security summarization system 106, which receives cloud log data 102 and contextual information 104. Security summarization system 106 executes a series of steps using internal components to generate human readable summary 118. Security summarization system 106 may be deployed in the cloud and be used by cloud system administrator to detect and prevent malicious activity.

Cloud log data 102 is log data associated with any cloud service provider (CSP). Examples of CSPs include Amazon Web Services™ (AWS), Google Cloud Platform™ (GCP) Microsoft Azure™, etc. CSPs may include a service that generates cloud log data 102. For example, AWS includes CloudTrails™. Such a service may generate log data for all activities on the cloud and store cloud log data 102 in a storage/database instance, for future retrieval.

Cloud log data 102 may include a wide variety of data associated with cloud environments. Any actions executed on the cloud may generate metadata associated with the action. These actions may include identity and access management actions (e.g., user login/logout events, multi-factor authentication usage, role assumption, changes to user permissions or IAM policies, creation or deletion of IAM users, roles, or groups), compute actions (e.g., starting, stopping, rebooting, or terminating virtual machines), storage actions (e.g., file uploads, downloads, or deletions, access to encrypted files or modification of encryption settings), network actions (e.g., DNS updates, configuration changes to security groups or firewall rules, and creation, modification or deletion of virtual private clouds), database actions (e.g., query execution logs, database instance creation or deletion), audit and configuration management (e.g., enabling/disabling logging or monitoring), application and application program interface (API) activity (e.g., API calls made by users or services, request/response metadata), and/or anomalous or security-related events (e.g., unusual location access, access attempts outside of business hours, data exfiltration patterns, privilege escalation attempts). Cloud log data 102 may comprise the action and the metadata.

For example, when a user initiates an API call to provision a database instance within an enterprise cloud environment, the call may generate corresponding log data. This log data may include, but is not limited to the user ID, the API call, information about the user's session, security information about the user, source internet protocol of the user, etc. Even a single API call may result in the generation and storage of a substantial volume of data within cloud log data 102.

In many cases, cloud users perform a sequence of API calls to create workloads, carry out complex cloud operations, and/or during extended user sessions. For instance, to create an Elastic Container 2 (EC2)™ workload in AWS™, users may execute a sequence of requests such as: EC2: DescribeInstances, EC2: CreateTags, EC2: DescribeTags, EC2: AuthorizeSecurityGroupIngress, EC2: CreateKeyPair,

EC2: DescribeKeyPairs, EC2: Describe Vpcs, EC2: DescribeSubnets, etc. In some embodiments, each of these API calls will generate metadata. Each of these API calls and their associated metadata will be stored in cloud log data 102. This generates a large volume of data that is difficult for a large language model to gather any insights from. Security summarization system 106 can determine that the sequence of API calls corresponds to the initiation of an EC2 workload. Identifying the workload context in this manner provides a major advantage in determining the security relevance of the associated API calls. By recognizing that the calls are part of a legitimate workload, the system can differentiate between normal operational behavior and anomalous or potentially malicious activity. This contextual understanding enhances the system's ability to detect threats, reduce false positives, and prioritize security responses based on the criticality of the workload.

Furthermore, cloud log data 102 may comprise interleaved or mixed workloads. For example, a user may concurrently operate an application involving EC2 and Relational Database System (RDS) resources while simultaneously retrieving data from unrelated Storage 3 (S3) buckets for analysis. Accurately identifying and disentangling these individual workloads from a mixed sequence of activity is a non-trivial task that necessitates the use of specialized models and processing techniques.

In some embodiments, users engage in activity that is relevant from a security-audit perspective through executing cloud actions. Activity that is relevant from a security-audit perspective may be an activity which might present a security risk if it is being executed by a malicious actor. Examples of activities that may be relevant from a security-audit perspective include changing which security permissions an identity can access (e.g., through Identity and Access Management (IAM) services), unauthorized access attempts, privilege escalation, unusual login locations, excessive data downloads, changes to access control settings, creation of new user accounts, deletion of audit logs, modification of security groups, failed login attempts, deployment of new virtual machines, data exfiltration attempts, changes to encryption settings, access to sensitive data, use of deprecated APIs, disabling of security tools, etc.

Activity that is relevant from a security-audit perspective can be present in cloud log data 102 amongst a plethora of data that is irrelevant from a security-audit perspective. Identifying the security-audit relevant data can be very difficult.

Security summarization system 106 may use contextual information 104 to enhance insights into cloud log data 102. Contextual information 104 may be generated from a variety of sources. For example, the CSP that generates cloud log data 102 may generate cloud inventory data. Other examples of data that may be included in contextual information 104 include Human Resource Management System (HRMS) data (e.g., from Okta™), relationship network data, identities data, resource data, permissions data, authentication data, authorization data, ticket data (e.g., JIRA), tags used for organization and access control applied to cloud resources, etc.

Contextual information 104 may be used to contextualize the data included in cloud log data 104. For example, HRMS data may indicate the permission level that a user with a particular identifier (ID) is authorized to have within an enterprise. In some embodiments, HRMS is used to determine whether a user ID of a low-level employee is attempting to access a database restricted to managerial personnel. In some embodiments, HRMS indicates the security posture of a user, such as: whether the user is still an employee in good standing, what the user's role is within the company (e.g., database administrator, cloud developer, auditor), whether the user has turned on Multi-Factor Authentication (MFA) and whether the user has had one or more recent failed password attempts and/or one or more recent failed MFA requests.

In some embodiments, contextual information 104 includes historical cloud log data. This historical data may be used for anomaly detection.

Using contextual information 104, security summarization system 106 can better determine whether pieces of cloud log data 104 are relevant from a security-audit perspective. Furthermore, human readable summary 118 may include contextual information 104 in its summary.

Security summarization system 106 uses ML techniques and other components to generate human readable summary 118 from cloud log data 102 and contextual information 104.

In some embodiments, security summarization system 106 uses knowledge harvester 110 to harvest knowledge from cloud log data 102 and contextual information 104. Condenser 112 is then used to condense the knowledge by extracting security critical information and dropping unimportant details. This condensed information can then be sent to summarizer module 114 to generate a human readable summary 118. Security summarization system 106 may be implemented using one or more servers, one or more computers, one or more virtual machines, etc.

Knowledge harvester 110 gathers data from a plurality of different sources. In some embodiments, cloud log data 102 and contextual information 104 are first sent to knowledge harvester 110. Knowledge harvester 110 may be configured to extract key dimensions of cloud log data 102. Knowledge harvester 110 may be configured to enrich cloud log data 102 using contextual information 104 such that the enriched data allows for better detection of relevant information. Knowledge harvester 110 may be configured to use ML methods in order to detect information within cloud log data 102 that may be relevant from a security-audit perspective.

In some embodiments, knowledge harvester 110 pre-processes cloud log data 102 by extracting key dimensions. This may be necessary because cloud logs are often heavily verbose and may include information that is irrelevant for detecting security-audit relevant information. Key dimensions may be broken up into categories (e.g., user/device information, API call information, and context information). Examples of key dimensions include, but are not limited to, identity/authentication information, user agent strings, Internet Protocol (IP) addresses, API event types, API names, sources, services, API parameters used, account context, resources context, region context, timestamps, etc.

In some embodiments, knowledge harvester 110 utilizes contextual information 104 to determine the relevance of key dimensions within cloud log data 102. For example, knowledge harvester 110 may determine, based on contextual information 104, that User A has a developer-level access designation. However, cloud log data 102 may indicate that API calls originating from User A's account are directed towards admin resources. Such a discrepancy may be assigned a high relevance score, as it could indicate potentially unauthorized or anomalous activity.

In another example, knowledge harvester 110 may access to historical cloud log data indicating that User A typically accesses resources from a specific geographical location. If cloud log data 102 includes an action in which User A accesses resources from a different or anomalous location, knowledge harvester 110 may identify this deviation as highly relevant, as it may signify unusual or potentially unauthorized behavior.

In another example, knowledge harvester 110 can detect that a read action in a user account with sensitive data may be more relevant than a read action in an account that lacks sensitive data.

In another example, knowledge harvester 110 can collect past records of cloud actions that will be used by Expert System for Events and Findings 116 to determine a baseline of normal behavior for a user. In some embodiments, a baseline of normal behavior for a user is represented as a histogram of actions and their frequencies. Normal behavior is a set of actions that are within a threshold of the baseline. In some embodiments, this histogram is then used by the condenser 112 to remove behaviors that are commonplace for the user, focusing instead on unusual security-relevant events.

In some embodiments, knowledge harvester 110 determines a baseline of normal behavior for a user (e.g., which actions the user often executes, what times the user executes these actions, where the user executes these baseline actions, etc.) and removes behaviors associated with the normal behavior for the user, in order to focus on events which deviate from the baseline. Events which deviate from the baseline include anomalous actions associated with the user such as, the user executing an action that takes place from a different device, occurs at a strange time, occurs an excessive number of times, etc.

In another example, knowledge harvester 110 may be invoked to collect additional information about resources that feature prominently in unusual or risky cloud actions and then enrich the cloud data with information about these resources. This context may include tags indicating the relative importance of one resource over another, information about the centrality of the resource to business operations, or information about the sensitivity of the data stored in the knowledge harvester.

Knowledge harvester 110 can then utilize the enriched cloud log data to generate one or more retrieval augmented generated (RAG) based prompts. RAG is a method that enhances ML models by combining them with external knowledge. In some embodiments, different categories of information correspond to different RAG-based prompts. In some embodiments, contextual information 104 is used as external knowledge for one or more RAG-based prompts. Each RAG-based prompt may be designed for use an ML agent within statistical and ML models module 108. Cloud log data 102 may be analyzed using the RAG-based prompt on a component of statistical and ML models module 108.

For example, a RAG-based prompt may be generated for use on an anomalous action agent. The anomalous action agent may be an ML model such as an LLM. The RAG-based prompt may include key dimensions of cloud log data 102 (e.g., user and peer-group action histogram), contextual information associated with the key dimensions (e.g., access level of users, geolocation data of users from historical data, etc.), a list of actions, and a prompt that instructs an ML model to identify unusual/risky actions. The anomalous actions agent analyzes the enriched cloud log data and is configured to output any unusual/risky actions. This analysis may be sent to condenser 112.

In some embodiments, the analysis executed by knowledge harvester 110 includes determining the frequency of the same action. For example, it is important to indicate that a certain user attempted to login using a certain endpoint a large amount of times.

Statistical and ML models module 108 comprises various components which can analyze cloud log data 102 and contextual information 104. In some embodiments, statistical and ML models module 108 comprises one or more ML agents. Each of these agents may be used for specific tasks. The analysis produced by statistical and ML models module 108 may be sent to condenser 112. Each of these models may be trained in any manner that is appropriate to train ML models.

Statistical and ML models module 118 may include one or more ML models for analyzing cloud log data 102 and contextual information 104. This analysis may be used by knowledge harvester 110.

Examples of statistical and ML models which may be included in statistical and ML models module 118 are: workflow detection models, login anomaly models, ML models for detecting sequences of actions that can be summarized as a high-level workflows, ML models for detecting geo anomalies, behavior anomalies models, includes peer behavior models, and models configured to generate insights from an Identity-Resource-Entitlement Relationship Graph.

Features can be constructed for the models comprising statistical and ML models module 108 using a variety of methods. Each model may require different features. The features can be defined such that they can be extracted from cloud log data 102 and contextual information 104. The features may be derived by determining answers to queries and transforming the answers into a form that may be used by an ML model (e.g., using encoding, vectorization, weights that indicate the relative importance of actions and other features, etc.).

Condenser 112 is configured to extract the crucial information from the knowledge generated by knowledge harvester 110. In some embodiments, condenser 112 provides the extracted information to summarizer module 114. Condenser 112 can reduce the noise and number of tokens used by summarizer module 114 in the process of summarizing data. This also reduces the inference costs which allows for efficient summarization.

One problem with using any LLM is the token size limit for LLMs. This prevents an LLM from analyzing large amounts of data. This is problematic because extracting insightful information from cloud log data requires the input of the cloud log data and the contextual information of the cloud log data. One option is to fit these large inputs into LLMs with the highest context window. However, such models often lead to higher cost per token leading to enormous summarization costs. Another option is to build custom ML models with a larger context size. However, this strategy may still require high training and inference costs due to a higher Graphic Processor Units (GPUs) memory requirement.

Condenser 112 can solve these problems by generating data with less tokens. In some embodiments, condenser 112 is configured to condense knowledge by extracting security critical information from the knowledge. Determining security critical information may be accomplished using a variety of different methods.

In some embodiments, condenser 112 is configured to utilize an action risk scoring model to identify the most significant actions given a lengthy sequence of actions performed on the cloud. This lengthy sequence of actions may be within enriched cloud data from knowledge harvester 110.

For example, condensation may involve eliminating actions that are commonly used by the user and the users' peers.

For example, condenser 112 may indicate that read operations are less important than write operations. However, certain read actions, such as actions which can be used for information gathering for future attacks may need extra scrutiny. An example of such an action is s3: GetObjectAcl.

Write actions such as s3: PutObjectAcl may be considered more critical, since it can potentially grant access to unauthorized users as a part of an attack.

The action risk scoring model may be used to analyze actions on the cloud by analyzing sensitive information exposure, privilege exposure, resource exposure, data access level, retains actions, and other actions that are important from a security standpoint. This categorization can be further enhanced by leveraging service level scores in addition to the scores based on access levels for actions. This way, actions belonging to the same access level across services can be prioritized appropriately.

In some embodiments, condenser 112 is configured to extract the relevant attributes for each action and discard the rest. The most relevant attributes may then be sent to summarization module 122. For example, when creating an S3 bucket, the region of the bucket might be of interest. Condenser 112 may extract the region of the bucket.

Identifying the most relevant attributes is a non-trivial task since every action on the cloud has a different set of attributes. This problem may be addressed by curating a database of significant attributes for common cloud actions and parsing the logs to extract these attributes. In some embodiments, condenser 112 addresses this problem by accessing a curated database of significant attributes for common cloud actions. Condenser 112 may then parse cloud log data 102 and/or cloud log data generated by knowledge harvester 110 to extract the most significant attributes in the cloud log data.

In some embodiments, after identifying the most significant actions, condenser 112 extracts the most relevant attributes associated with the most significant actions.

In some embodiments, condenser 112 produces condensed knowledge by collating significant actions and relevant attributes. This collated data may be forwarded to summarizer module 114.

In some embodiments condenser 112 reduces the volume of log data by collapsing duplicate actions rather than passing a sequence of events to the summarizer. For example, a sequence of actions: A1, A1, A2, A3, A3, A1 may be reduced to A1(2), A2, A3(2), A1 by combining adjacent actions and indicating the number of actions in sequence with a count. Alternatively, it may be educed further to A1(3), A2, A3(2), showing each action only once. Each action may also be enriched with additional detail, such as a risk score or access level. For example, if A1=s3: ListBucket, A2=s3: PutBucket, and A3=s3: DeleteBucket, the condensed output may be the following: s3: ListBucket (count=3,access-level=List,risk=2), A2=s3: PutBucket (count=1,access-level=WriteData,risk=30), and A3=s3: DeleteBucket (count=2,accessl-level=DeleteData,risk=40).

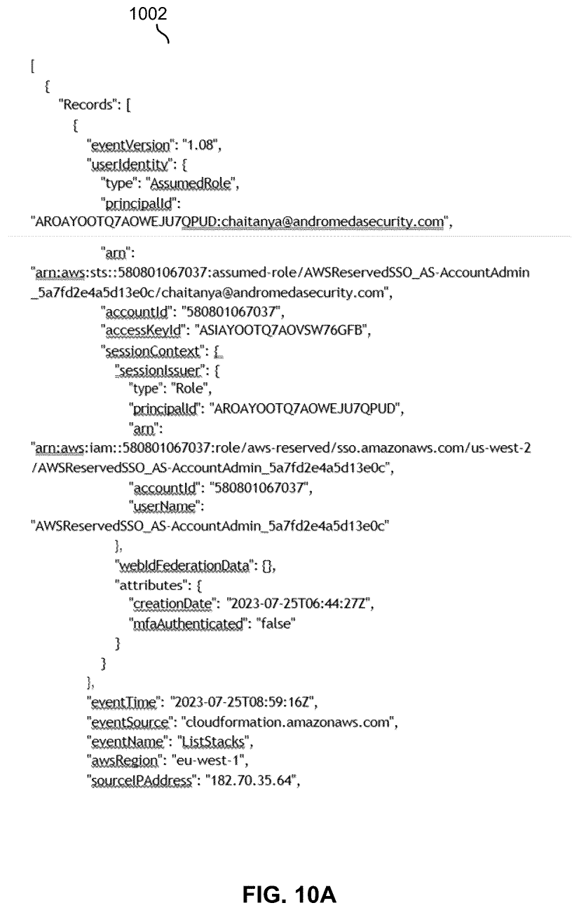

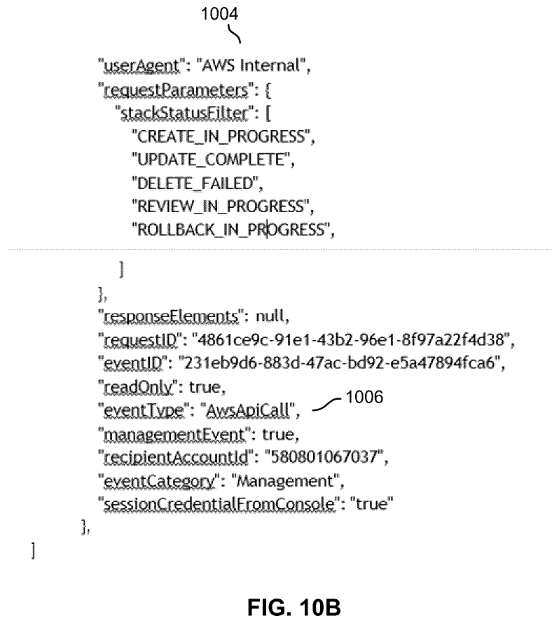

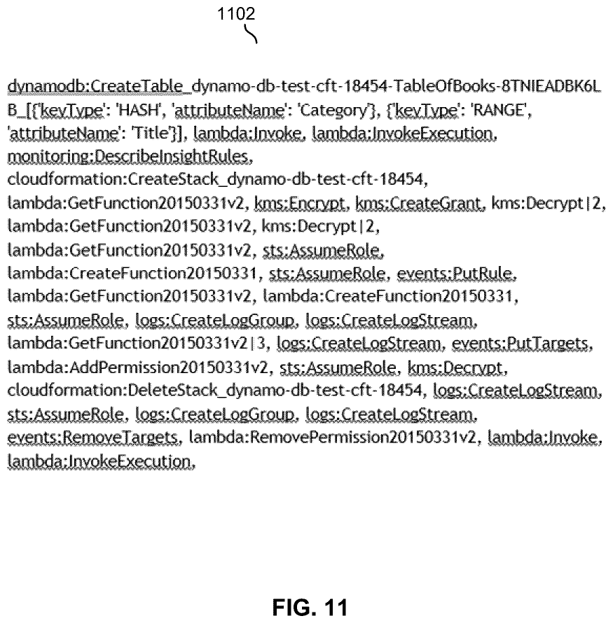

Examples of inputs for condenser 112 are provided in FIGS. 10A-B. An example output of condenser 112 is provided in FIG. 11.

### Summarizer Module

Summarizer module 114 is configured to take data associated with the cloud as input and generate a human readable summary. In some embodiments, the data associated with the cloud comprises a sequence of actions. In some embodiments, the data associated with the cloud comprises cloud log data 102. In some embodiments, summarizer module 114 receives data associated with the cloud from condenser 112.

Summarizer module 114 may include any LLM. The LLM may be a public LLM, a private LLM, or a hybrid LLM. Examples include ChatGPT™, ClaudeAI™, Google Gemini™, . . . , etc. In some embodiments, an API for these LLMs is used. Security summarization system 106 may be configured to use one of these LLMs through an API.

In some embodiments, summarizer module 114 comprises a custom summarization model that is trained to leverage domain expertise through curation of the right data to get the exact kind of security session summaries that add value to human readers, such as cloud administrators.

### Custom Summarization Model Training

In some embodiments, a completely custom model is trained from scratch. This may involve starting with an architecture that works for summarization. Examples of starter architectures include Transformers, Bidirectional and Auto-Regressive Transformers (BART), Text-to-Text Transfer Transformer (T5), Pre-training with Extracted Gap-sentences for Abstractive Summarization (PEGASUS), Generative Pre-trained Transformer (GPT), BERT for Extractive Summarization (BERTSUM), Predicting Future N-gram for Sequence-to-Sequence Pretraining (ProphetNet), Long-Document Transformer (Longformer), Longformer Encoder-Decoder (LED), Multilingual Text-to-Text Transfer Transformer (mT5), etc.

The starter architecture may be fed adequate high quality training data to enable it to create high quality security session summaries. The number of parameters in the model determines the amount of training data required. For example, a custom model may begin with 300 million to 7 billion parameters.

In some embodiments, summarizer module 114 comprises a model that is fine-tuned. Fine tuning a model involves transfer learning where the last few layers of a model are trained to customize the model and produce security summaries with high quality training data. The advantage of this approach is that lesser training data is required compared to training all the weights of the model.

Both of the approaches described above depend on generation of high quality data. In some embodiments, summarizer module 114 comprises a base LLM that is fine-tuned using supervised fine tuning with curated example summaries. In some embodiments, security summarization system 106 automatically re-creates the publicly available examples of cloud operations/activity and uses it to create enriched data sets for supervised learning.

In some embodiments, synthetic LLM generated data is also implemented to systematically generate summary scenarios, and corresponding condensed extractive machine summaries that can be a part of the prompt for supervised fine tuning.

In some embodiments, a framework to incorporate user intent from the Just-In-Time (JIT) request and the associated support tickets (Example: JIRA, ServiceNow, etc.). This may be used to automatically create training data for supervised learning. For example, <condensed_log, summary> pairs may be generated and used as training data to finetune/train a model. In some embodiments, several real workloads of CSPs are generated, the logs are collected, and high-quality summaries are manually (e.g., by a human) created to generate training data.

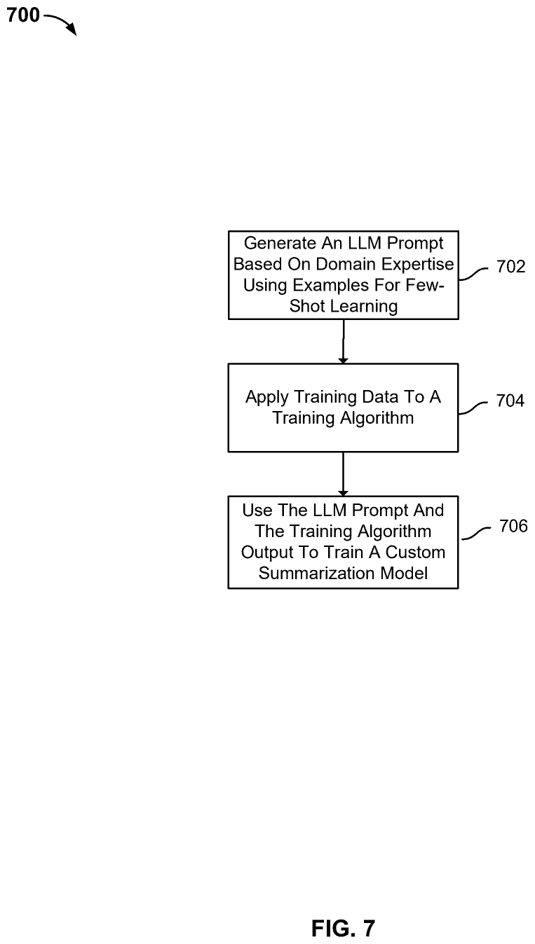

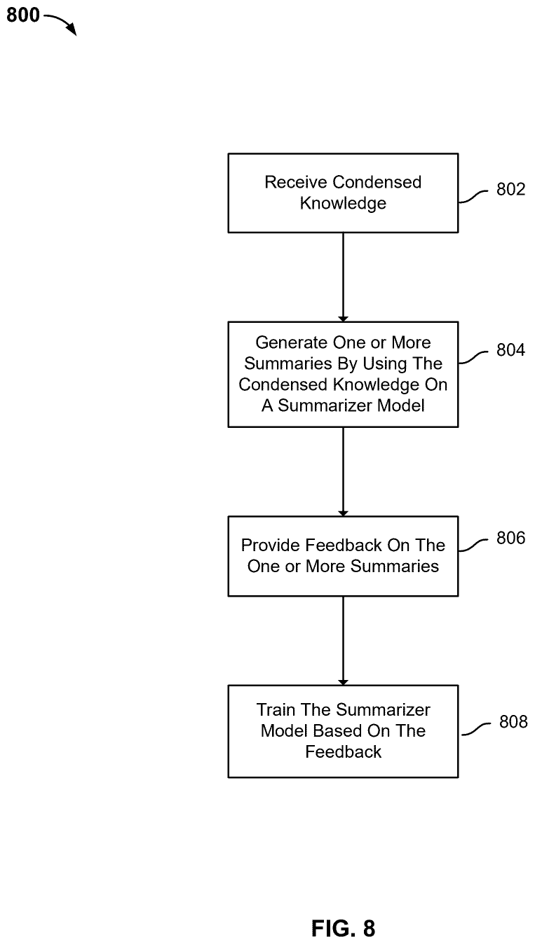

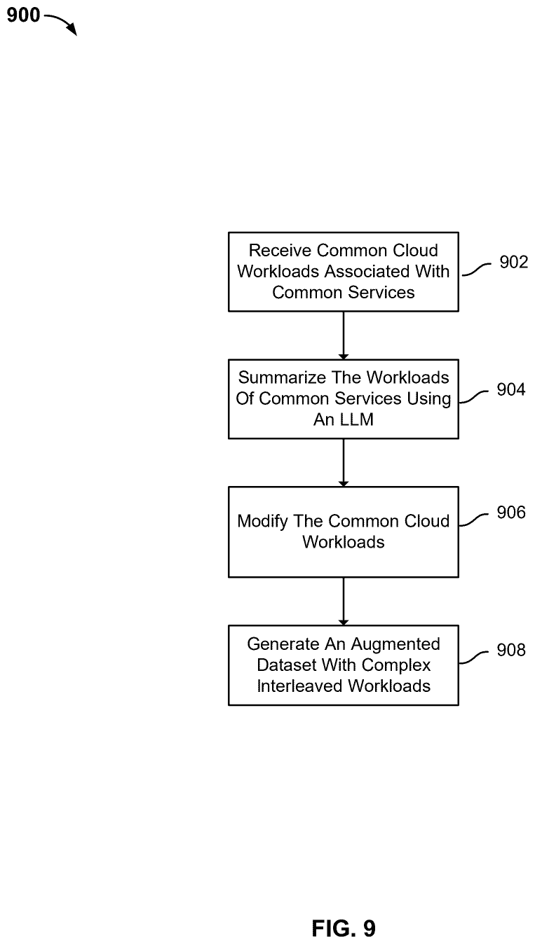

An example of a process to train a custom model for summarizer module 114 is provided in FIG. 7. An example of a process to train a summarizer module 114 using feedback is provided in FIG. 8. An example of a process for generating training data for summarizer module 114 is provided in FIG. 9.

In some embodiments, an LLM is trained using LLM generated data. For example, a set of cloud services that are commonly used is generated (e.g., EC2, S3, DynamoDB, EKS, RDS, etc.). Descriptions of common workflow patterns associated with the commonly used set of cloud services are generated using an LLM. Condensed logs are generated for these summaries by leveraging an LLM. In some embodiments, the condensed logs are summarized and compared with the original summaries (workflow descriptions) using standard metrics (e.g., BERT score, BLEU score, etc.). The standard metrics may be used to discard the bad pairs of training data. In some embodiments, a manual review of the <condensed_log, summary> pairs is performed to ensure bad data points are discarded/corrected ensuring high quality data. The remaining pairs may be used to train summarizer module 114.

In some embodiments, datasets are curated based on feedback from customer data. Logs may be extracted from customer data and used to generate carefully curated summaries for workloads where the scope for improvement in terms of summarization is seen. Datasets may be curated based on a combination of these processes to create high quality training data for summarizer module 114.

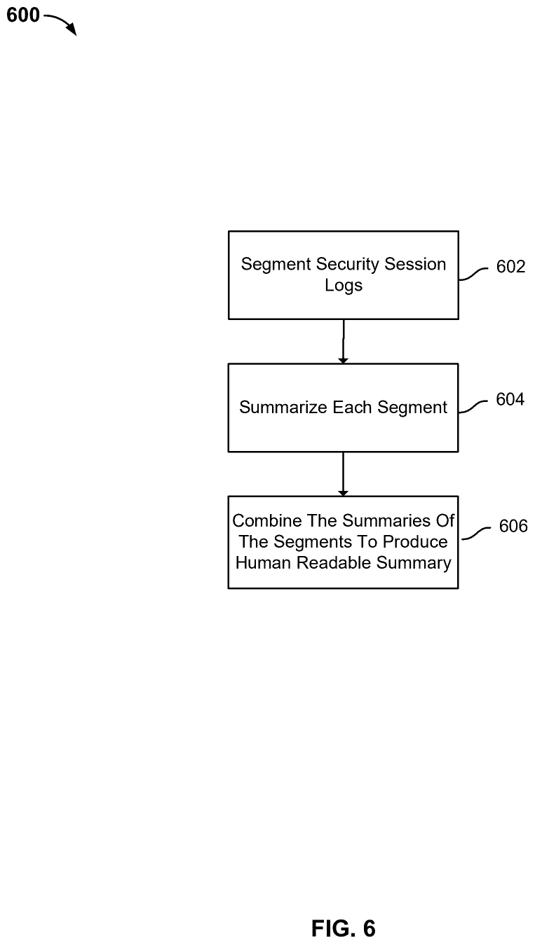

In some embodiments, security summarization system 106 includes logic to summarize extremely large sessions. This may be done by breaking the session up into multiple small chunks, summarizing individual sessions, and combining the individual summaries to get a final summary. In some embodiments, a custom LLM model that is finetuned or trained is used for combining multiple summary chunks to produce a final summary. An example of a process for using segmentation/session chunking to produce a summary for a large session is provided in FIG. 6.

An example of an output summary that can be generated by summarizer module 114 is provided below:
The user created a cloudformation stack named “dynamo-db-test-cft-7374” and a lambda function.
The user created and deleted a table named “dynamo-db-test-cft-7374-TableOfBooks-152DJLVUMBS3D” in DynamoDB.
The user deleted the cloudformation stack “dynamo-db-test-cft-7374” and the lambda function.

Expert system for events and findings 116 is configured to provide condenser 112 a list of one or more anomalies and/or one or more alerts. In some embodiments, expert system for events and findings 116 analyzes cloud log data 102 and detects certain activity that is easy to detect and useful for extracting security-audit relevant information. For example, expert system for events and findings 116 can be configured to detect when a new user is created in the system that is not included in the Identify Provider (IdP) system. This enhances the ability of security summarization system 106 to detect security-audit relevant information and generate human readable summary 118. Detection of such an anomaly may trigger automated alerts, initiate further investigation workflows, or adjust the risk score associated with the affected user or system component, thereby enabling faster and more effective incident response.

Expert system for events and findings may also collect existing findings provided via RAG, such as from the HRMS and identity provider modules. These may include such things as whether the user is still an employee in good standing, what the user's role is within the company (e.g., database administrator, cloud developer, auditor), whether the user has turned on Multi-Factor Authentication (MFA) and whether the user has had one or more recent failed password attempts and/or one or more recent failed MFA requests.

Expert System for Events and Findings 116 may also use data from Knowledge Harvester 110 to determine a baseline of normal behavior for a user. In some embodiments, this is represented as a histogram of actions and their frequencies. In some embodiments this histogram is then used in collaboration with the condenser 112 to remove actions that are commonplace for the user and that have been reviewed before, focusing instead on unusual security-relevant events.

Human readable summary 118 is a textual summary of cloud log data 102 and contextual information 104. In some embodiments, human readable summary 118 comprises information from cloud log data 102 and contextual information 104 that is relevant from a security-audit perspective.

In some embodiments, human readable summary 118 is generated through a multiple step process using the components of security summarization system 106. For example: knowledge harvester 110 harvests knowledge from cloud log data 102 and contextual information 104, condenser 112 condenses the knowledge by extracting security critical information from the knowledge, and summarizer module 114 produces human readable summary 118 by summarizing the condensed knowledge.

Human readable summary 118 can be used by humans attempting to secure a cloud environment. This includes cloud information security officers (CISOs), software engineers, cloud security experts, etc. Human readable summary 118 can be used to detect malicious activity and determine a method to prevent the malicious activity. For example, human readable summary 118 may indicate that a specific user is engaging malicious activity. An action can be taken to prevent this user from accessing the cloud environment (e.g., blocking the user).

In some embodiments, security summarization system 106 implements a framework for hierarchical summarization. This may be implemented as a part of summarizer module 114. This includes using adaptive granularity in summary detail (e.g., human readable summary 118) based on the amount of supporting actions. For example, when there are a sparse set of actions performed for a specific service, specifically for a high-access level, these actions are explicitly enumerated. In some embodiments, a series of actions is aggregated to provide a high-level view of the activity when there are several such supporting actions.

In some embodiments, security summarization system 106 implements a mechanism to customize the hierarchical summarization based on the custom access level scores to ensure low risk actions are deprioritized in the presence of higher risk actions in a summary (e.g., human readable summary 118). Relevance may be highly contextual based on the specific criticality and data sensitivity of account and resource.

In some embodiments, security summarization system 106 utilizes an ensemble model to generate multiple responses from summarizer module 114 and selects the best response based on a summary score. In some embodiments, the cost is lowered by choosing a cheaper model with fewer parameters. The quality of a lower cost model may be improved by generating multiple summaries and picking the best response based on one or more evaluation metrics.

In some embodiments, security summarization system 106 incorporates textual summaries and data coming from anomaly-detection modules coming from Statistics and ML Models 202.

In some embodiments, security summarization system 106 implements knowledge distillation for training a custom, smaller, low cost and targeted LLM summarizer (starting for instance from a 7 billion parameter Llama model) for generating security summaries. This LLM summarizer may leverage learning from a larger model through the use of knowledge distillation loss and/or synthetic training data generation from a larger model to reduce the summarization cost incurred by invoking an external LLM.

In some embodiments, security summarization system 106 implements reinforcement learning to improve weights of one or more ML models included in summarizer module 114. The reward function can be formulated using the evaluation metrics described below and an update algorithm such as policy gradient optimization (PPO) or using the actor critic method.

In some embodiments, security summarization system 106 implements reinforcement learning with human feedback (RLHF) through an audit process of the generated summaries by providing ideal summaries and inputs on crucial information missing in the summary. In some embodiments, the RLHF process is enhanced by customer feedback collected from a user interface (e.g., feedback on human readable summary 118). This feedback may be provided in the form of a summary score, a thumbs up/thumbs down mechanism, and/or preference data between multiple summaries generated.

In some embodiments, security summarization system 106 includes an anomaly rule engine which aggregates data from cloud log data 102 and contextual information 104 (e.g., HRMS and cloud inventory data) to highlight the unusual user activities in addition to high risk and high access level cloud actions.

In some embodiments, failed cloud actions and categorization of erroneous actions by levels of criticality are highlighted. For example, authorization errors might be more important to show in the summary, particularly when the error occurred on a high-risk action. In some embodiments, adaptive treatment of error information, where significant detail on the errors is shown when there are a few errors on critical services, while a high-level overview of errors is shown otherwise.

In some embodiments, security summarization system 106 includes logic to select an appropriate LLM model based on the size of the input data associated with the LLM and number of input tokens and the characteristics of an instance of cloud log data 102 and/or contextual information 104.

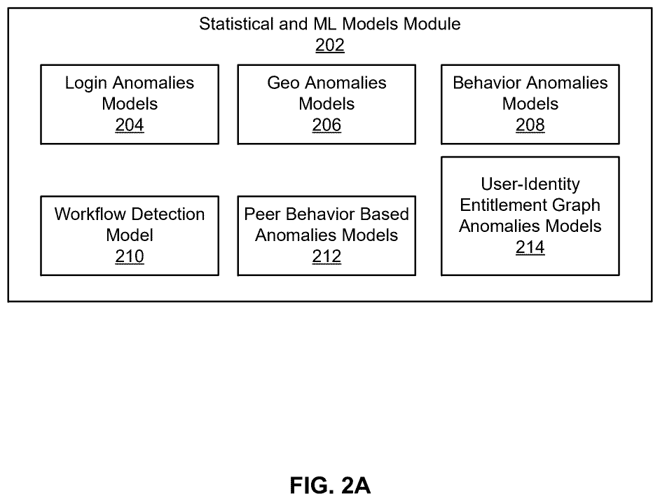

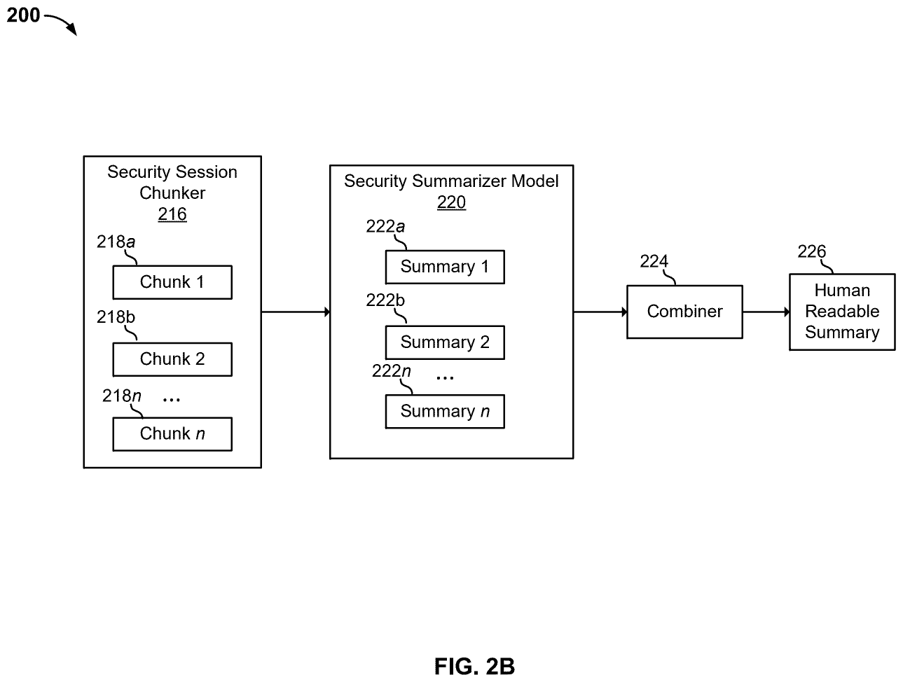

FIG. 2A is a block diagram of a statistical and ML model module in accordance with some embodiments. In some embodiments, statistical and ML models module 202 is integrated into a security summarization system, such as security summarization system 106. Statistical and ML models module 202 may receive information associated with cloud data (e.g., cloud data logs and/or contextual information). Statistical and ML models module 202 may be used to analyze cloud log data.

Statistical and ML models module 202 may be used to determine and indicate data within large amounts of cloud data and contextual data that is relevant from a security-audit perspective.

Statistical and ML models module 202 may also be used to process cloud data and generate a condensed summary of events and high-level behaviors that are relevant from a security-audit perspective.

Login anomalies models 204 are configured to help determine possible anomalies based on login information. Examples of login information include number of login failures, time of failures, time of attempts among other features, etc. Login anomalies models 204 may use one or more statistical techniques that model the sequence of previous login attempts and infer an anomaly probability. Login anomalies models 204 may also use discriminative models that learn to classify anomalous login attempt sequences in a supervised fashion.

Login anomalies models 204 may include a user agent anomaly detection model. A user agent anomaly detection model is a security or behavioral analytics model designed to identify unusual or suspicious patterns in user agent strings-metadata that identifies the software, device, and operating system used to access a system or service (e.g., browser type, OS version, device type).

Geo anomalies models 206 are configured to determine possible location-based anomalies. For example, these models may detect anomalous behavior when a user logs in from places far apart within a short time frame. Access from an unusual location among other features could indicate an anomaly. However, detecting such anomalies can be non-trivial-for instance the user may be behind a Virtual Private Network (VPN).

Behavior anomalies models 208 detect anomalous behavior based on a sequence of actions. These models may be based on sequence modelling. Techniques used by behavior anomalies models 208 may include supervised machine learning based sequence models (such as Hidden Markov Models (HMMs), Recurrent Neural Networks (RNNs), transformers, etc.) for identifying known attack vector patterns. Behavior anomalies models 208 may be configured to identify unusual sequences with unsupervised techniques such as time-series clustering or time-series anomaly detection models.

Workflow detection models 210 include one or more models configured to detect sequences of actions that can be summarized as a high-level workflows. These sequences may be performed by a human or by a service. For example, when an EC2™ instance is created, the following steps are performed: accessing an Image, Creating an EC2 instance, attaching network interface and attaching IP address. Workflow detection models 210 may detect that these individual actions combined are the workflow for creating an EC2 instance.

Workflow detection models 210 may be used to determine whether actions are executed by a CSP console or by a user. In some embodiments, actions executed by a CSP console are suppressed. For example, logging in from the console may result in many API calls that are not explicitly actions performed by the user. These are not necessarily relevant from a security-audit perspective.

In some embodiments, there may be a hierarchy consisting of multiple workflow steps, for instance creation of a load balancer involves individual workflow steps of creation of a subnet, an application load balancer (ALB), a web application firewall (WAF) policy, firewall rule and load balancing pool certificate configuration. A model may detect that these individual actions combined are the workflow for creating a load balancer.

In some embodiments, a multi-prompt framework is implemented with a RAG framework to select the appropriate prompt based on the workflow detected. For example, when a certain workflow is detected, a certain RAG-based prompt may be created and used to further analyze that workflow.

In some embodiments, the workloads are mixed workloads.

Peer-behavior based anomalies models 212 are configured to determine if the behavior of an entity deviates from that of its known peers in an unusual fashion. To illustrate, let peer group Nᵢ=n₁, n₂, nₘ be the profiles of peer entities of user i. The models learn the function p(Aᵢ|nᵢ, Nᵢ) which determines the probability that a particular identity i is anomalous given its behavior and that of its peer group.

User-identity entitlement graph anomalies models 214 are configured to generate insights from a graph that relates user identities, resources and entitlements such as an Identity-Resource-Entitlement Relationship Graph. An Identity-Resource-Entitlement Relationship graph may be constructed from contextual information, such as cloud inventory data. Cloud inventory data is a rich source of information that leverages the relationships between multiple identities, resources, and entitlements on a cloud environment. User-identity entitlement graph anomalies models 214 may use node embeddings to analyze data.

Node embeddings may be derived from a representation using various deep learning techniques. The node embeddings can be used to derive multiple insights relationship data within an Identity-Resource-Entitlement Relationship graph. Furthermore, deeper insights may be derived by leveraging exogenous attributes of individual nodes such as the type or the location of an identity, the risk of an entitlement, etc.

### Constructing Features for Statistical and ML Models

Features can be constructed for statistical and ML models module 202 using a variety of methods. Each model may require different features. Features are representations of data associated with cloud log data and contextual information. The features may be constructed using training data (e.g., for use in training) and/or use in analyzing data (e.g., cloud log data and/or contextual information).

The features can be defined such that they can be extracted from cloud log data and contextual information. The features may be derived by determining answers to queries and transforming the answers into a form that may be used by an ML model (e.g., using encoding, vectorization, etc.).

Example features that may be derived from leveraging the following information about the individual user, peer-based information and group information are provided below. These features may be used by a variety of models within statistical and ML models module 202 including login anomaly models 204, peer behavior based anomalies models 212, and user-identity entitlement graph anomalies models 214.

### User Level Features:

Customer profile has cluster of IP addresses.
Has IP Address been used in the past?
How many times has the IP address been used in the past?
IP Address type? Public/Private/Proxy
Distance from the most recent IP address used?
Least Distance from previous “n” IP addresses used
“Travel time” from most recent IP address
Distance from home location?
In published set of addresses in company?

In some embodiments, geo anomalies models 206 uses peer features where peers are defined as those that are part of the same group in the user's organization. This may be determined from HRMS data. Examples of group based features are provided below:

### IDP Group-based Features:

How many peers have used from same geo zone as user
How many peers have used from same geo zone as user within the same time window
How many times have peers used on an average in the past in comparison with this user
Deviation from Average IP reputation score within peer group
Common Device Types: Prevalence of different device types within the peer group.
Operating System Distribution: Distribution of operating systems among peers.
Browser Diversity: Variety and frequency of browsers used by the peer group.

In some embodiments, geo anomalies models 206 uses organizational level features to check if other users from the same organization have used the IP address. Examples of organization-based features are provided below:

### Organization-based Features:

Is the time Within Organizations peak usage periods?
How many organization members in the same time zone as the current request
How many organization members are using the same operating system as current user
Deviation from Average IP reputation score within organization
Common Device Types: Prevalence of different device types within the peer group.
Operating System Distribution: Distribution of operating systems among peers.
Browser Diversity: Variety and frequency of browsers used by the peer group.

Features that may be used for models within login anomaly models 204 (e.g., a user agent anomaly detection model) may be created by leveraging information associated with the specific browser used by the user on a specific device. Examples of these features include:
Has Device Address been used in the past?
How often has the Device been used in the past?
When was the last time the device was used in the past?
Has the Operating system been used in the past?
How often has the operating system been used in the past?
When was the last time the operating system was used in the past?

In some embodiments, any anomaly detection model (e.g., login anomaly models 204, geo anomalies models 206, behavior anomalies models 208, user-identity entitlement graph anomalies models) can use request features to detect an anomaly, such as:
How many times in the past week has the user recorded activity at this time of the day?
How many times in the past month has the user recorded activity at this time of the day?
How many times in the past month has the user recorded activity on this day of the week (weekday vs weekend).

In some embodiments, anomaly detection models implement univariate statistical models such as Z-Score, mean/median absolute deviation, box plots and other similar techniques with a weighing function to give adequate weights to various univariate features.

In some embodiments, anomaly detection models implement unsupervised multivariate anomaly detection techniques such as isolation forests, one class SVMS, clustering based approaches (e.g., hierarchical agglomerative clustering, k-means, DBSCAN, etc.).

In some embodiments, anomaly detection models implement multivariate supervised anomaly detection techniques such as logistic regression, SVM, deep learning models, etc.

In some embodiments, anomaly detection models implement supervised sequence based classifier models based on the sequence of actions requested such as hidden Markov models, recurrent neural networks or transformer-based models to identify which sequence of actions are similar to those that have occurred in a fraudulent user session and may be indicative of an attack pattern.

In some embodiments, anomaly detection models implement unsupervised based models that analyze the sequence of cloud actions using sequence embeddings. This may be done using embedding techniques such as autoencoders and other sequence models such as transformers and RNNs.

In some embodiments, the anomaly detection models implement graph based embedding models which leverage the connections between various users (peer, belong to the same organization, etc.) and connections between users and actions using techniques such as graph neural networks.

### Use of Synthetic Data

In some embodiments, synthetic data is generated and used to train ML models within statistical and ML models module 202. For example, synthetic data that simulates anomalies by generating unusual patterns of geo location, device agent, time of pattern request, etc. can be generated and used to train ML models. This may be facilitated by generating synthetic features for the synthetic data.

FIG. 2B is a block diagram of a system for summarizing a plurality of chunks of information in accordance with some embodiments. System 200 can be used to summarize long sessions of cloud activity. In some embodiments, summarizer module 114 comprises system 200.

System 200 includes security session chunker 216, security summarizer model 220, and combiner 224. Security session chunker 216 takes in a large amount of cloud log data (e.g., a series of cloud actions) and breaks it into chunks 218a, 218b, . . . , 218n. It is often important to ensure that context is not lost by breaking cloud log data into chunks. This may be done by identifying optimal points to break up a large amount of cloud log data.

Security session chunker 216 receives data associated with a cloud log and generates chunks 218a, 218b, . . . , 218n. This is done by breaking up the data associated with a cloud log. In some embodiments, security session chunker 216 receives data associated with a single cloud session. The session may be so long that it requires segmentation. In some embodiments, security session chunker 216 receives data from a condenser (e.g., condenser 112). Security session chunker 216 sends chunks 218a:n to security summarizer model 220.

Chunk 218a, 218b, . . . , 218n are chunks of data associated with a cloud log. In some embodiments, chunks 218a:n include data that has been produced by a condenser (e.g., condenser 112). Each chunk 218n comprises an amount of information that is under a threshold.

For example, each chunk 218n may comprise characters which are less then a max_characters. Although, there are only three chunks shown there may be any number of chunks.

Security summarizer model 220 generates summary 222a, 222b, . . . , 222n which correspond to chunks 218a:n. Security summarizer model 220 receives chunks 218a:n. Security summarizer model 220 may use any method to generate summaries 222a:n. In some embodiments, security summarizer model 220 uses ML techniques to generate summaries 222a:n. In some embodiments, security summarizer model 220 comprises an LLM which is used to generate summaries 220a:n. Security summarizer model 220 may use any of the techniques described above to generate summaries 222a:n.

Summary 222a, 222b, . . . , 222n comprises human readable information about chunks 218a:n. In some embodiments, summary 222a, 222b, . . . , 222n each directly correspond to chunk 218a, 218b, . . . , 218n, respectively. Summaries 222a:n are sent to combiner 224.

Combiner 224 receives summaries 222a:n and combines them into human readable summary 226. In some embodiments, combiner 224 uses a combiner language model (e.g., an LLM) with an appropriate prompt to combine summaries 222a:n into human readable summary 226.

In some embodiments, system 200 utilizes a multiway merge and combine strategy to produce human readable summary 226 from summaries 222a:n. Using this strategy, each chunk 218n is summarized. Then all of the separate summaries 222a:n are combined by combiner 224.

In some embodiments, system 200 utilizes summary chaining to produce human readable summary 226 from summaries 222a:n. Summary chaining refers to a technique in which multiple summaries are generated sequentially, with each summary building upon or incorporating information from the preceding ones. This approach is particularly useful in scenarios where the input data is too large to be effectively summarized in a single step-such as with extensive cloud logs or lengthy documents. It is also employed when maintaining context or continuity across summarization stages is important, or when the summarization model, such as an LLM, is constrained by input or output length limitations. By processing and refining information in stages, summary chaining enables the generation of coherent and comprehensive summaries from large-scale or fragmented datasets.

Using this strategy, chunks 218a:n are summarized one chunk at a time along with the summary of all previous chunks. This may be executed by security summarizer model 220. Using this strategy, combiner 224 may be unnecessary and human readable summary 226 may be directly produced by security summarizer model 220.

Human readable summary 226 comprises a textual summary of the cloud associated data associated with chunks 218a:n.

### Security Session Summary Evaluation Strategy

Evaluating the quality of a summary (e.g., human readable summary 226 and/or independent summaries summary 222a, 222b, . . . , 222n) is a non-trivial task. Standard Natural Language Processing (NLP) metrics such as perplexity, the bilingual evaluation understudy (BLEU) Score, recall-oriented understudy for gisting evaluation (ROUGE) Score or bidirectional encoder representations from transformers (BERT) Score may help check whether a summary is meaningful at a high level. However, these methods may be unable to distinguish between summaries that are useful from a security perspective and summaries that are less interesting from a security perspective.

An evaluation framework is crucial to perform iterative improvements of the system and ensure that high quality summaries are generated.

In some embodiments, one or more NLP metrics are used to evaluate the quality of summary. In some embodiments, perplexity is used to measure summary fluency while BLEU and/or ROUGE score are used to measure how well the summary adheres to the condensed extractive machine summary provided in an associated prompt. The associated prompt may be used by a summarizer component (e.g., an LLM) with the data that is summarized.

In some embodiments, specialized metrics are designed for security summary evaluation. These metrics can be crucial in designing a system that can evolve and improve in response to feedback. The following are some examples of specialized metrics:

### Recall Metrics

These metrics are used to ensure that important data (e.g., cloud log data and/or contextual information) is included in a summary. A summary may be an intermediate summary (e.g., a summary of a chunk) and/or a human readable summary.
1. Service Recall: This metric is calculated by dividing the number of unique services covered in a summary by the number of unique services provided in data associated with cloud logs (e.g., condensed knowledge). Identifying a service in a summary can be achieved by doing a case insensitive match and/or a semantic match with unigrams and bi-grams. For example, these methods can detect that a service called “secretsmanager” is represented by “Secrets manager” in data associated with cloud logs.
2. Crucial Service Recall: This metric is calculated by dividing the number of unique crucial services covered in summary by the number of unique crucial services provided in data associated with cloud logs (e.g., condensed knowledge, cloud logs, condensed cloud logs, etc.). In some embodiments, service level scores are used to identify crucial services. A similar recall metric as the service recall may be computed for crucial services.
3. Crucial Action Recall: This metric is calculated by dividing the number of unique crucial actions in summary by the number of unique crucial actions in data associated with cloud logs (e.g., condensed knowledge, cloud logs, condensed cloud logs, etc.).

Action level scores may be used to identify which actions are crucial. In some cases, the exact action name might not be used in the summary. For example, “The user interacted with AWS™ Lambda, creating and deleting functions, as well as invoking them” might refer to lambda: CreateFunction lambda: DeleteFunction and lambda: InvokeFunction. However, it is hard to detect this using simple text match. This issue may be addressed by using a specialized classifier model to detect if a piece of text is referring to a specific action. Recall metrics, such as service recall and critical action recall may be used to ensure that all crucial information in the session is covered in the summary.

### Precision Metrics

Precision metrics can be used to ensure that a module that produces summaries (e.g., a security summarizer model, a summarizer module, and/or a component of a summarizer module such as an LLM, etc.) is not hallucinating by including non-existent services and actions in a summary.
1. Service Precision: This metric reflects the fraction of detected services in the summary that are actually in data associated with cloud logs (e.g., condensed knowledge, cloud logs, condensed cloud logs, etc.). This metric is calculated by dividing the unique services in the summary and in the data associated with cloud logs by the number of unique services present in the summary.
2. Crucial Service Precision: This metric is calculated by dividing the number of unique crucial services in data associated with cloud logs by the number of unique crucial services present in the summary.
3. Crucial Action Precision: This metric is calculated by dividing the number of unique crucial actions in the summary and in the data associated with the cloud logs by the number of unique crucial actions present in the summary.

Precision metrics, such as service precision and action precision, may be determined to ensure all services and actions that occur in the summary are indeed a part cloud log and/or data associated with a cloud log (e.g., a condensed cloud log). This is done to prevent hallucinations by module that produces summaries such as those arising from an LLM.

In some embodiments, an overall security summary score is calculated by combining the precision metrics and the recall metrics. The overall security summary score may be generated by aggregating the individual metrics and weighting the scores based on the risk score of the specific missing services/actions and/or the hallucinated service and actions.

In some embodiments, NLP techniques are implemented to identify services and actions in the summary text by leveraging Parts of Speech tags and dependency parse along with domain specific rules to compute service recall and critical action recall. In some embodiments, scores are further aggregated using an Inverse LP norm with the appropriate p or other aggregation strategies such as the harmonic mean. This can be done to ensure that if an important action is missing, the overall score is low even if the generated summary covers other actions.

In some embodiments, a supervised machine learning classifier is implemented based on a sequence model such as a transformer to identify the occurrence of a service and/or action entity in a summary. This identification can be used for computing precision and recall metrics.

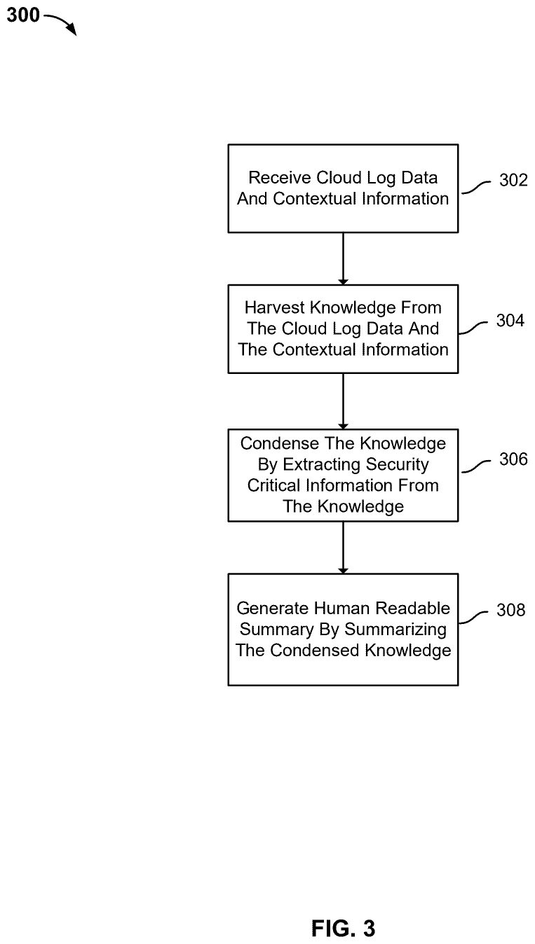

FIG. 3 is a flow diagram of a process for generating a human readable summary of cloud data in accordance with some embodiments. Process 300 may be implemented by a security summarization system, such as security summarization system 106.

At 302, cloud log data and contextual information is received. Cloud log data is log data associated with any CSP. Cloud log data may include any actions/requests executed on a CSP environment. Examples of actions/requests include user login attempts, API requests, resource creation events, configuration changes, access control modifications, data upload and download activity, service errors, authentication failures, network traffic details, virtual machine start and stop events, storage access logs, permission changes, firewall rule updates, system alerts, etc.

Contextual information may be any information that can contextualize the cloud log data. Examples include, but are not limited to: user identity, geolocation data, time of access, device type, user role or permissions, historical activity patterns, IP address reputation, organization policies, workload context, threat intelligence feeds, network topology, compliance requirements, business hours, anomaly detection baselines. In some embodiments, contextual information includes HRMS data.

At 304, knowledge is harvested from the cloud log data and the contextual information. Harvesting knowledge comprises extracting key dimensions from the cloud log data.

Key dimensions may be broken up into categories (e.g., user/device information, API call information, and context information). Examples of key dimensions include identity/authentication information, user agent strings, Internet Protocol (IP) addresses, API event types, API names, sources, services, API parameters used, account context, resources context, region context, timestamps, etc.

In some embodiments, the contextual information is used to enrich the key dimensions of the cloud log data. This allows for better detection of information relevant from a security-audit perspective. In some embodiments, harvesting knowledge includes detecting relevant information in enriched key dimensions. This may be done by using one or more statistical and ML models.

In some embodiments, knowledge harvesting includes using the enriched key dimensions and/or cloud log data to generate one or more RAG-based prompts. The RAG-based prompts may include the enriched key dimensions and a prompt for an ML model, wherein the prompt includes a query for analysis.

The RAG-based prompts may be used on any statistical and/or ML model. This is done to analyze the enriched cloud log data. For example, a RAG-based prompt may include directions and context for a ML model to determine whether a condensed list of actions should be identified as unusual/risky behaviors. The ML model can indicate where it has identified these behaviors for use in the future.

At 306, the knowledge is condensed by extracting security critical information from the knowledge. Extracting the security critical information from the knowledge includes determining which information is most relevant for a human readable summary of the cloud log data and contextual information. The information that is security critical may be information that is relevant from a security-audit perspective.

Security critical information may be identified using a variety of different methods. For example, an action risk scoring model can be used to identify the most significant actions within the harvested knowledge. In another example, the most relevant attributes are extracted for each cloud action and the rest of the attributes are discarded.

In some embodiments, condensing knowledge includes reducing the noise and number of tokens of the knowledge.

In some embodiments, condensed knowledge is generated by collating significant actions and relevant attributes.

At 308, a human readable summary is generated by summarizing the condensed knowledge. A human readable summary is a text-based summary of cloud log information and/or contextual information. Using process 300, the human readable summary will comprise the most relevant cloud log information from a security-audit perspective, such that a cloud administrator can efficiently use the human readable summary to detect/prevent malicious activity in a cloud environment. Human readable summary 118 can be used by humans attempting to secure a cloud environment. Examples include software engineers, cloud security experts, etc.

In some embodiments, the human readable summary is generated by using the condensed knowledge on a ML model (e.g., an LLM). In some embodiments, the human readable summary is generated by using the condensed knowledge on a summarizer module. The summarizer module may include various components for producing human readable summary (e.g., a custom summarization model, transformers, etc.).

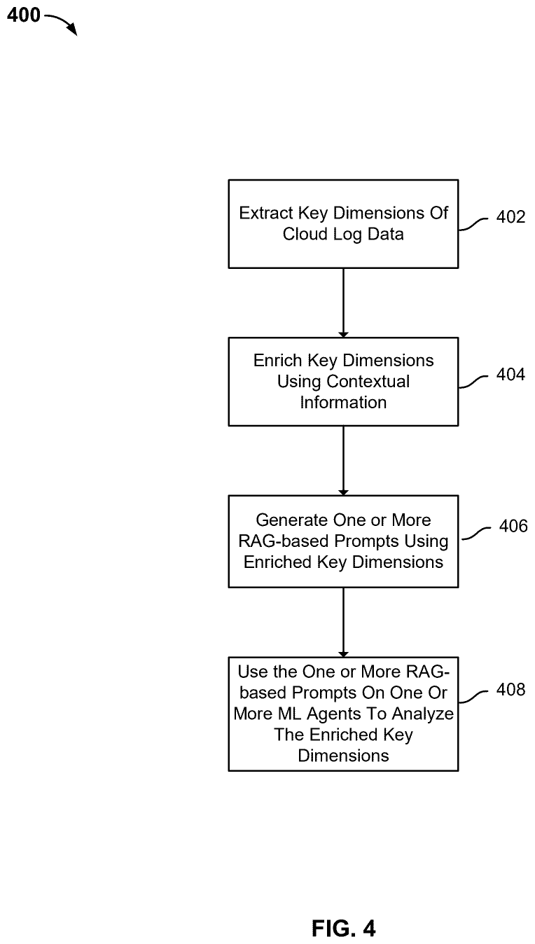

FIG. 4 is a flow diagram of a process for harvesting knowledge from cloud data in accordance with some embodiments. Process 400 may be executed by a knowledge harvester, such as knowledge harvester 110. Process 400 may be implemented to perform some or all of step 304 of process 300.

At 402, key dimensions of cloud log data are extracted. The cloud log data may be received at a security summarization system. Key dimensions include any data that may be useful from a security-audit perspective. For example, it may be useful to include the user-ID of each action because this information may be relevant to determining whether a user is attempting to access information that is beyond that user's security clearance.

Other examples of key dimensions includes identity/authentication information, user agent strings, IP addresses, API event types, API names, sources, services, API parameters used, account context, resources context, region context, timestamps, etc.

At 404, the key dimensions are enriched using contextual information. Contextual information is any data that can provide context to the cloud log data, including the key dimensions. Referring to the example, the context information for the user-ID may include the position of that user within a company. This may be determined through use of an organization chart. Examples of contextual information include HRMS data (e.g., from Okta™), relationship network data (such as the organization chart and manager relationships), identities data, resource data, permissions data, authentication data, authorization data, ticket data (e.g., JIRA), etc.

Enriching the key dimensions is useful for providing context to actions and/or requests. For example, it is important to know what rank someone is in a company for determining if they are attempting to access data that is above their rank.

At 406, one or more RAG-based prompts are generated using the enriched key dimensions. In some embodiments, a RAG-based prompt includes instructions, enriched key dimensions. The instructions may be used to instruct an ML model to analyze the key dimensions using certain areas of exploration. For example, a RAG-based prompt for a login anomalies model may include instructions for an ML model to detect when a user is attempting to login an excessive amount over a short period. This may be indicative of a malicious actor attempting to hack into the user account.

At 408, the one or more RAG-based prompts are used on one or more ML agents to analyze the enriched key dimensions. This produces harvested knowledge in a wide variety of metrics. Examples of ML agents include, but are not limited to: workflow detection models, login anomaly models, ML models for detecting sequences of actions that can be summarized as a high-level workflows, ML models for detecting geo anomalies, behavior anomalies models, includes peer behavior models, and models configured to generate insights from an Identity-Resource-Entitlement Relationship Graph.

This analysis includes whether these enriched key dimensions comprise any information that is relevant from a security-audit perspective. This analysis is used to identify this information for future use (e.g., by a condenser).

In some embodiments, enriched key dimensions are also sent to an expert system for events and findings.

In some embodiments, the harvested knowledge produced at step 408 is sent to a condenser.

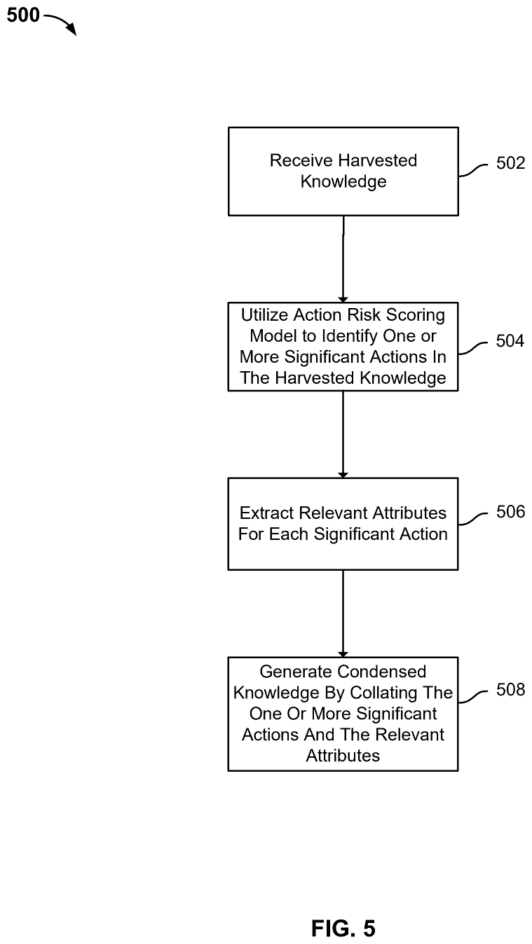

FIG. 5 is a flow diagram of a process for condensing knowledge of cloud data in accordance with some embodiments. Process 500 may be executed by a condenser, such as condenser 112. Process 500 may be implemented to perform some or all of step 306 of process 300. Process 500 may include reducing the noise and number of tokens of knowledge.

At 502, harvested knowledge is received. Harvested knowledge may be received from a knowledge harvester. Harvested knowledge may be generated by harvesting knowledge from cloud log data and contextual information. In some embodiments, harvested knowledge includes cloud log data and contextual data that has been analyzed by one or more statistical and/or ML models such that important data is present.

At 504, an action risk scoring model is used to identify one or more significant actions in the harvested knowledge. Actions may include identity and access management actions, compute actions, storage actions, network actions, database actions, etc. The action risk scoring model may be used to analyze actions on the cloud by analyzing sensitive information exposure, privilege exposure, resource exposure, data access level, retains actions, and other actions that are important from a security standpoint. The action risk scoring model can score these actions based on their relevance from a security-audit standpoint.

In some embodiments, all actions of the harvested knowledge are given an action risk score using the action risk scoring model. Using the action risk score, one or more significant actions can be identified. For example, the actions with the highest 10 scores may be identified as the significant actions.

At 506, relevant attributes for each significant action is extracted. Examples of attributes of an action include: name, description, action type, parameters, credentials, timeout, return values, region, error messages, permissions, encryption, retry policy, execution mode, dependencies, API endpoint, service provider, version, status, etc. Some attributes associated with an action may be less relevant than others from a security standpoint. For example, when creating an S3 bucket, the region of the bucket might be of interest.

In some embodiments, curated database of relevant/significant attributes for common cloud actions is used to identify relevant attributes.

At 508, condensed knowledge is generated by collating the one or more significant actions and the relevant attributes. The significant actions and the relevant attributes may be collated in any manner. For example, each significant action may be associated with its relevant attributes. The condensed knowledge may be used by a summarizer module to generate a human readable summary.

FIG. 6 is a flow diagram of a process for summarizing condensed knowledge in accordance with some embodiments. Process 600 can be executed by a summarizer module, such as summarizer module 114. Process 600 may be used on any data associated with cloud data logs, enriched cloud data logs, harvested knowledge, condensed knowledge, etc. Process 600 may be used to summarize large amounts of cloud log data.

At 602, security session logs are segmented. The security session logs may be comprised of cloud log data and/or contextual data. In some embodiments, the security session logs include cloud log data and/or contextual data that has been processed (e.g., by a condenser). Segmentation includes breaking the security session log into multiple segments of information, where the amount of information within the segments is under a threshold. For example, each segment may have a number of characters that are less than a max_characters, where max_characters is an integer.

This enables the use of LLMs which have a limited context window for large inputs. By segmenting the security session logs into smaller segments, the LLM can summarize each segment individually. This significantly reduces the training and inference costs that would otherwise be required to process and summarize the entire security session log in a single pass. At 604, each segment is summarized. Each segment may be summarized using a security summarizer module. In some embodiments, each segment is summarized using ML techniques. In some embodiments, an LLM is used to generate the summaries of each segment.

At 606, the summaries of the segments are combined to produce a human readable summary. This may be done by a combiner. In some embodiments, a combiner language model (e.g., an LLM) with an appropriate prompt to combine the summaries of the segments into a human readable summary.

In some embodiments, summary chaining is used to produce a human readable summary. Summary chaining refers to a technique in which multiple summaries are generated sequentially, with each summary building upon or incorporating information from the preceding ones. In some embodiments, step 604 and step 606 are executed in a manner such that summary chaining is the result.

FIG. 7 is a flow diagram of a process for training a summarization model in accordance with some embodiments. In some embodiments, process 700 is used to train a summarizer model that is a part of a summarizer module, e.g., summarizer module 114.

At 702, an LLM prompt based on domain expertise is generated using examples for few-shot learning. The examples for few-shot learning may include data associated with cloud logs (e.g., condensed knowledge) and a human readable summary associated with the cloud log data and/or contextual information. In some embodiments, the human readable summary is produced by a security expert.

In some embodiments, the LLM prompt is enhanced with domain specific risk scores and custom access levels that consider the risk score for individual. This is done to ensure higher risk actions are covered more prominently in the security summary.

At 704, training data is applied to a training algorithm. The training data is adequate high quality training data which enables the generation of high-quality security session summaries. In some embodiments, the training data is generated using an LLM.

The training algorithm may comprise a fine-tuning algorithm that can be used to fine tune the data. The training algorithm may be used to extract high quality training data for use in training the LLM. This enables an LLM to produce high quality security session summaries. The high-quality training data includes pairs of information associated with cloud log data (e.g., cloud log data and contextual information) paired with tailored high-quality summaries of the information associated with cloud log data.

At 706, the LLM prompt and the training algorithm output are used to train a custom summarization model. In some embodiments, the custom summarization model includes a base model that is further trained using few-shot learning and the training algorithm output.

In some embodiments, the number of parameters in the model determines the amount of training data required. In some embodiments, a summarization model may begin with 300 million to 7 billion parameters.

The custom summarization model may include a base LLM such as GPT-3, GPT-4, LLAMA, etc. This base LLM may be fine-tuned using the LLM prompt and the training algorithm output, such that it is more proficient at generating security summaries from cloud log data.

FIG. 8 is a flow diagram of a process for training a summarization model using feedback in accordance with some embodiments. Process 800 may be used to train a summarizer model that is used in a summarizer module, such as summarizer module 114.

At 802, condensed knowledge is received. Condensed knowledge includes cloud log data and contextual information that has been processed. Condensed knowledge may include harvested knowledge that has been condensed. Condensing may be executed by a process such as process 500. In some embodiments, condensing is executed by a condenser, such as condenser 112.

At 804, one or more summaries are generated by using the condensed knowledge on a summarizer model. The summarizer model may be a base model. The summarizer model may be a custom model that has been trained using a process such as process 700. The summarizer model may be a fine-tuned model. The summarizer model may be a model that has been trained using few-shot learning.

At 806, feedback is provided on the one or more summaries. In some embodiments, the feedback includes ranking the one or more automatic summaries. In some embodiments, the feedback includes texts which details how good the summary is. In some embodiments, the feedback is generated by a human. In some embodiments, the feedback is generated using a ML model such as an LLM.

In some embodiments, NLP metrics such as BLEU, ROGUE, BERT, etc. are used alone or in combination to provide feedback for the one or more automatic summaries. In some embodiments, various metrics such as service recall, crucial service recall, crucial action recall, etc. are used to provide feedback for one or more automatic summaries. In some embodiments, precision metrics such as service precision, crucial service precision, crucial action precision, are used to provide feedback on the one or more summaries. These metrics may be calculated by a human and/or programmatically. In some embodiments, a supervised learning method is used to provide feedback on the one or more summaries.

At 808, the summarizer model is trained based on the feedback. This may be done by readjust or reconfiguring the model such that it generates summaries that conform more closely to the feedback. This can be done using feedback or finetuning methods. This can be done using any method to retrain a ML model such as an LLM.

For example, the model may be trained RLHF through an audit process of the generated summaries by providing ideal summaries and inputs on crucial information missing in the summary. In some embodiments, the RLHF process is enhanced by customer feedback collected from a user interface. This feedback may be provided in the form of a summary score, a thumbs up/thumbs down mechanism, and/or preference data between multiple summaries generated.

FIG. 9 is a flow diagram for generating an augmented dataset in accordance with some embodiments. Process 900 may be used to generate data that can be used to train any ML model which can be used to extract meaningful insights out of cloud log data and/or contextual information. For example, process 900 may be used to generate data for training any statistical and ML models. Process 900 may be used to generate data for training any summarizer models.

Process 900 may be used to generate summaries which summarize a particular workload within an interleaved workload. Interleaved workloads are generated when users perform multiple activities at a time in an interleaved pattern. For example, a user may be attempting to generate two separate cloud instances during a single session. This leads to complex interleaved workloads in the cloud log data logs. Process 900 generates summaries of these workloads for use as training data.

At 902, common cloud workloads associated with common services are received. Common services may be CSP specific such as EC2 on AWS™. The workloads may be any actions and/or groups of actions that are commonly performed with regards to the service. For example, creating an EC2 instance on AWS™. The common cloud workloads associated with the common cloud services may be received in the form of cloud log data.

Common services include any cloud services that are commonly used. The services may be commonly used by executing a series of actions. Examples services include: compute services (e.g., computing large amounts of data), storage services (e.g., generating storage instances and storing data), networking (e.g., creating/configuring network services), content delivery (e.g., generating methods for delivering content), monitoring (e.g., generating monitoring instances that monitor cloud resources), etc. The LLM receives these services and cloud log data associated with these services and generates a summary about each of the services.

At 904, the workloads of common services are summarized using an LLM. An LLM, such as GPT-4, may be used with CSP provided data and the data received in step 902 to generate a summary of the workload for the service. For example, the LLM can generate summaries and action sequences for each service.

At 906, the common cloud workloads are modified. They may be modified by changing call attributes, combining atomic workflows to make a complex workflow, summary pairs, and/or by strategically adding filter actions between significant actions. This has the effect of generating real world workloads that may be executed by humans on a CSP environment. For example, the workload of creating an EC2 instance on AWS™ can be combined with one or more actions associated with the workload of creating an S3 instance on AWS™.

At 908, an augmented dataset with complex interleaved workloads is generated. This is accomplished by combining the modified common cloud workloads with a summary of the common workload of the common services. Referring to the example, the interleaved workload of creating the EC2 instance is paired with the LLM generated summary that summarizes the workload of creating an EC2 instance.

Thus, the pair of the interleaved workload and a correct summary can be used to train a summarizer model. This can be used to train models that are better at identifying the common workloads in real world condensed cloud log data inputs.

FIGS. 10A-10B depicts an example of a condenser input in accordance with some embodiments. Condenser input part 1 1002 and condenser input part 2 1004 comprises the cloud log data generated when an action is performed. In this example, the eventType 1006 is an AwsAPICall. Condenser input part 1 1002 and/or condenser input part 2 1004 may be provided to a condenser such as condenser 112.

In some embodiments, condenser input part 1 1002 and condenser input part 2 1004 are generated by a knowledge harvester. For example, condenser input part 1 1002 and condenser input part 2 1004 may be parts of a larger set of cloud log data, but have been harvested using a knowledge harvester.

FIG. 11 depicts an example of a condenser output in accordance with some embodiments. Condenser output 1102 demonstrates a list of actions/requests that are executed on a CSP. These may be generated after a large amount of condenser input (e.g., condenser input part 1 1002 and condenser input part 2 1004) is condensed by a condenser (e.g., condenser 112). In some embodiments, condenser output 1102 is used on a summarizer module to generate a summary about cloud log data.

Condenser output 1102 comprises security critical information from knowledge that has been harvested.

Condenser output 1102 demonstrates important actions/requests that are found within the cloud log data. These important actions/requests are determined by executing a condensing process such as process 500.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
harvest knowledge from cloud log data and contextual information;
condense the knowledge by extracting security critical information from the knowledge; and
generate a human readable summary by summarizing the condensed knowledge; and
a memory coupled to the processor and configured to provide the processor with instructions.

2. The system of claim 1, wherein the cloud log data includes one or more of: identity and access management actions, compute actions, storage actions, network actions, configuration changes to security groups or firewall rules, modification of virtual private clouds, database actions, audit and configuration management, application and application program interface (API) activity, and anomalous or security-related events.

3. The system of claim 1, wherein the contextual information includes one or more of: cloud inventory data, Human Resource Management System (HRMS) data, relationship network data, identities data, resource data, permissions data, authentication data, authorization data, and ticket data.

4. The system of claim 1, wherein the processor is further configured to receive the cloud log data and the contextual information.

5. The system of claim 1, wherein to harvest the knowledge from the cloud log data and the contextual information, the processor is configured to:
extract key dimensions of the cloud log data;
enrich the key dimensions using the contextual information; and
generate one or more retrieval augmented generation based (RAG-based) prompts using the enriched key dimensions; and
use the one or more RAG-based prompts on one or more machine learning (ML) agents to analyze the enriched key dimensions.

6. The system of claim 5, wherein the one or more ML agents includes one or more of the following: workflow detection models, login anomalies models, behavior anomalies models, geo anomalies models, peer behavior based anomalies models, and user-identity entitlement graph anomalies models.

7. The system of claim 5 wherein the key dimensions include one or more of the following:
authentication information, user agent strings, Internet Protocol (IP) addresses, Application Program Interface (API) event types, API names, sources, services, API parameters used, account context, resources context, region context, and timestamps.

8. The system of claim 1, wherein to condense the knowledge, the processor is configured to:
utilize an action risk scoring model to identify one or more significant actions in the harvested knowledge;
extract relevant attributes for each of the one or more significant actions; and
generate the condensed knowledge by collating the one or more significant actions and the relevant attributes.

9. The system of claim 8, wherein to extract the relevant attributes, the processor is configured to use a curated database of relevant attributes from? common cloud actions to identify the relevant attributes.

10. The system of claim 1, wherein to generate a human readable summary by summarizing the condensed knowledge, the processor is configured to:
segment security session logs;
summarize each segment; and
combine the summaries of the segments to produce the human readable summary.

11. The system of claim 1, wherein to generate the human readable summary by summarizing the condensed knowledge, the processor is configured to train a custom summarization model.

12. The system of claim 11, wherein training the custom summarization model includes using fine-tuning on a base large language model (LLM).

13. The system of claim 11, wherein to train the custom summarization model, the processor is further configured to:
generate an LLM prompt based on domain expertise using examples for few-shot learning;
in apply training data to a training algorithm; and
use the LLM prompt and the training algorithm output to train the custom summarization model.

14. The system of claim 11, wherein to train the custom summarization model, the processor is further configured to:
receive condensed knowledge;
generate one or more summaries by using the condensed knowledge on a second summarization model;
provide feedback on the one or more summaries; and
train the custom summarizer model based on the feedback.

15. The system of claim 11, wherein training data for the custom summarizer model is generated by:
receive common cloud workloads associated with common services;
summarize the workloads of common services using an LLM;
modify the common cloud workloads; and
generate an augmented dataset with complex interleaved workloads.

16. The system of claim 15, wherein modifying the common cloud workloads includes one or more of the following: changing call attributes, combining atomic workflows to make a complex workflow, summary pairs, and strategically adding filter actions between significant actions.

17. The system of claim 1, wherein to harvest knowledge from cloud log data and contextual information, the processor is further configured to:
determine a baseline of normal behavior for a user; and
determine abnormal behavior for the user by removing one or more actions from a set of actions associated with the user that are within a threshold from the determined baseline of normal behavior.

18. The system of claim 17, wherein the baseline of normal behavior for a user is represented as a histogram.

19. A method, comprising:
harvesting knowledge from cloud log data and contextual information;
condensing the knowledge by extracting security critical information from the knowledge; and
generating a human readable summary by summarizing the condensed knowledge.

20. The method of claim 19, wherein harvesting knowledge from cloud log data and contextual information comprises:
extracting key dimensions of the cloud log data;
enriching the key dimensions using the contextual information; and
generating one or more RAG-based prompts using the enriched key dimensions; and
using the one or more RAG-based prompts on one or more ML agents to analyze the enriched key dimensions.

21. The method of claim 20, wherein the one or more ML agents includes one or more of the following: workflow detection models, login anomalies models, behavior anomalies models, geo anomalies models, peer behavior based anomalies models, and user-identity entitlement graph anomalies models.

22. The method of claim 19, wherein condensing the knowledge by extracting security critical information from the knowledge comprises:
receiving harvested knowledge;
utilizing an action risk scoring model to identify one or more significant actions;
extracting relevant attributes for each significant action; and
generating condensed knowledge by collating the one or more significant actions and the relevant attributes.

23. The method of claim 19, wherein generating a human readable summary by summarizing the condensed knowledge further comprises, training a custom summarization model, wherein training the custom summarization model includes using fine-tuning on a base large language model (LLM).

24. A computer program product embodied in a non-transitory computer readable medium and comprising computer instructions for:
harvesting knowledge from cloud log data and contextual information;
condensing the knowledge by extracting security critical information from the knowledge; and
generating a human readable summary by summarizing the condensed knowledge.
